(19) United States
(12) Patent Application Publication
(10) Pub. No.: US 2014/0321887 A1
(43) Pub. Date: Oct. 30, 2014

(54) DEVELOPING DEVICE, PROCESS CARTRIDGE, AND IMAGE FORMING APPARATUS

(71) Applicant: Canon Kabushiki Kaisha, Tokyo (JP)

(72) Inventors: Takeshi Matsumoto, Yokohama-shi (JP); Masanari Morioka, Yokohama-shi (JP)

(73) Assignee: Canon Kabushiki Kaisha, Tokyo (JP)

(21) Appl. No.: 14/262,115

(22) Filed: Apr. 25, 2014

(30) Foreign Application Priority Data
Apr. 25, 2013 (JP) 2013-092766

(51) Int. Cl. G03G 15/08

(52) U.S. Cl. CPC G03G 21/1676; G03G 21/1814
USPC 399/284

(57) ABSTRACT

A developing device for an image forming apparatus includes a developing roller for carrying a developer; a developing blade including a blade member for regulating a developer amount carried on a surface of the developing roller and a supporting member for supporting the blade member; and a frame supporting the supporting member: wherein the supporting member is fixed to the frame in a state that a first region thereof adjacent the blade member tends to expand and a second region thereof remote from the blade member tends to contract, such that a stretching force is applied to the blade member in a rotation axial direction of the developing roller, and the blade member is fixed to the supporting member in the first region.

### FIELD OF THE INVENTION AND RELATED ART

The present invention relates to an image forming apparatus, such as a copying machine, a printer, and the like, which is provided with a function to form an image on a sheet of recording medium or the like. In particular, it relates to a developing apparatus to be employed by an image forming apparatus.

There have been available various image forming methods. According to one of these methods, a development cartridge, in which developer is stored, is disposed in such a manner that the cartridge opposes a photosensitive drum, and the developer in the cartridge is transferred onto a sheet of recording medium to form an image on the sheet. Some development cartridges are made up of a developer container, a development roller, a development blade, etc. In the case of such development cartridges, the developer stored in a developer container is made by magnetic, electrostatic, or the like force to be coated (borne) on the peripheral surface of the development roller, and is formed by the development blade into a thin layer of developer which is preset in thickness. The thin layer of developer on the peripheral surface of the development roller is transferred onto the peripheral surface of the photosensitive drum, in the pattern of the latent image formed on the peripheral surface of the photosensitive drum, forming thereby a visible image, that is, an image formed of the developer. This image formed of the developer is transferred onto a sheet of recording medium. Consequently, an image is formed on the sheet of recording medium. Therefore, in order to ensure that an image is satisfactorily formed on a sheet of recording medium, it has to be ensured that a thin layer of developer is satisfactorily formed on the peripheral surface of a development roller. In order to ensure that a thin layer of developer is satisfactorily formed on the peripheral surface of a development roller, it is important that the state of contact between the development blade for forming a thin layer of developer and the development roller is uniform in terms of the lengthwise direction of the development roller.

Many development blades are made up of a thin plate which is several tens to hundreds μm in thickness, and a base plate which is for providing the development blade with rigidity, and to which the thin plate is attached at multiple points. A development blade is subjected to thermal stress which occurs as ambient temperature changes, and also, load to which the development blade is subjected when it is attached to the development container. Thus, a development blade of the above-described type is sometimes deformed in such a manner that its thin plate portion becomes wavy. Once the thin plate portion of the development blade becomes wavy, the development blade fails to contact the development roller in such a manner that the state of contact between itself and development roller becomes uniform in terms of the lengthwise direction of the development roller. Thus, it is possible that the thin layer of developer formed by the development blade will not be uniform in thickness, and therefore, will be enable to form a satisfactory image on the peripheral surface of a photosensitive drum. One of the known methods for solving this problem is to provide a development cartridge with a means which can provide the thin plate portion of the development blade with a certain amount of tension directed in the lengthwise direction of the development blade, when the development blade is fixed to the developer container, and/or when the thin plate portion of the development blade is fixed to the base plate portion of the development blade (Japanese Laid-open Patent Applications H07-325481, and 2002-72671).

### SUMMARY OF THE INVENTION

However, because of the positional relationship between the points of the thin plate portion, at which the thin plate portion is attached to the base portion, and the points of the base portion, at which the base portion is attached to the thin plate portion, it is possible that a conventional method such as the above described one will compress the portions of fixation between the thin plate portion and base plate portion of the development blade. Thus, in order to prevent the thin plate portion of the development blade from being deformed in a wavy pattern, the amount of force to be applied to the development blade to fix the development blade to the developer container has to be adjusted so that the thin plate portion of the development blade is provided with a proper amount of tension. This adjustment requires a substantial amount of time.

The present invention was made in consideration of the above-described problem. Thus, the primary object of the present invention is to prevent the thin plate portion of the development blade from becoming wavy.

According to an aspect of the present invention, there is provided a developing device for an image forming apparatus, comprising a developing roller for carrying a developer; a developing blade including a blade member for regulating a developer amount carried on a surface of the developing roller and a supporting member for supporting said blade member; and a frame supporting said supporting member: wherein said supporting member is fixed to said frame in a state that a first region thereof adjacent said blade member tends to expand and a second region thereof remote from said blade member tends to contract, such that a stretching force is applied to said blade member in a rotation axial direction of said developing roller, and said blade member is fixed to said supporting member in the first region.

Further features of the present invention will become apparent from the following description of exemplary embodiments with reference to the attached drawings.

### BRIEF DESCRIPTION OF THE DRAWINGS

FIG. 1 is a schematic plan view of the development blade in one of the typical embodiments of the present invention.

FIG. 2 is a schematic cross-sectional view of the development blade shown in FIG. 1.

FIG. 3 is a schematic sectional view of the image forming apparatus in the embodiment of the present invention.

FIG. 4 is a perspective view of the development cartridge in the embodiment.

FIG. 5 is a drawing for describing how the development blade in the embodiment is attached to the developer container in the embodiment.

FIG. 6 also is a drawing for describing how the development blade in the embodiment is attached to the developer container in the embodiment.

FIG. 7 is a drawing for describing the state of deformation of the development blade in the embodiment.

FIG. 8 is a disproportionally enlarged schematic view of the base plate portion of the development blade in the embodiment.

### DESCRIPTION OF THE PREFERRED EMBODIMENTS

Hereinafter, one of the preferred embodiments of the present invention is described in detail. However, the measurements, materials, shapes of the structural components in this embodiment, and their positional relationships are not intended to limit the present invention in scope. Rather, they are to be modified according to the structure of apparatuses to which the present invention is applied, and various conditions under which apparatuses to which the present invention is to be applied are used.

### Embodiment

The following is the description of this embodiment of the present invention.

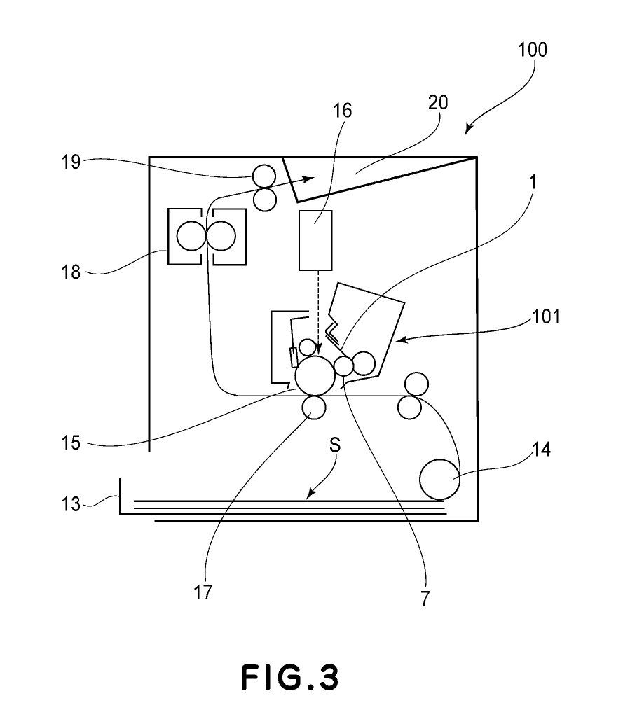

FIG. 3 is a schematic sectional view of the image forming apparatus 100 in this embodiment. The image forming operation of this apparatus 100 is as follows:

The numerous points of the peripheral surface of a photosensitive drum 15, as an image bearing member, are selectively exposed by an exposing device 16, in accordance with the information of an image to be formed. Consequently, an electrostatic latent image (which hereafter may be referred to simply as “latent image”) is effected on the peripheral surface of the photosensitive drum 1.

A development cartridge 101, as a developing device, carries out the following developing operation. First, developer (toner) is delivered to the peripheral surface of the development roller (developer bearing member) 7 by the developer delivery roller. Then, the delivered developer on the peripheral surface of the development roller 7 is formed by the development blade (developer regulating member) 1, into a thin layer of developer. To the development roller 7, development bias is applied, whereby the developer on the peripheral surface of the development roller 7 is transferred onto the peripheral surface of the photosensitive drum 15 in the pattern of the electrostatic latent image. As a result, a visible image is formed of the developer (toner), on the peripheral surface the photosensitive drum 15.

Next, transfer bias is applied to a transfer roller 17, whereby the visible image, that is, the image formed of the developer, on the peripheral surface of the photosensitive drum 15, is transferred onto a sheet S of recording medium while the sheet S is conveyed through the transfer nip which is the area of contact between the photosensitive drum 15 and transfer roller 17.

As for the sheet S of recording medium, multiple sheets S of recording medium are stored in layers in a sheet cassette 13 installed in the bottom portion of the main assembly of the image forming apparatus 100. They are conveyed out of the sheet cassette 13 by a sheet conveyance roller 14, so that the developer image on the peripheral surface of the photosensitive drum 15 will be transferred onto the sheet S of recording medium.

Thereafter, each sheet S of recording medium, onto which an unfixed developer image has been transferred, is conveyed to a fixing device 18, in which the sheet S and the developer image thereon are subjected to heat and pressure. Thus, the unfixed developer image on the sheet S becomes fixed to the sheet S. Then, the sheet S is discharged into a delivery tray 20, which is an integral part of the top wall of the casing of the image forming apparatus 100, by a pair of discharge rollers.

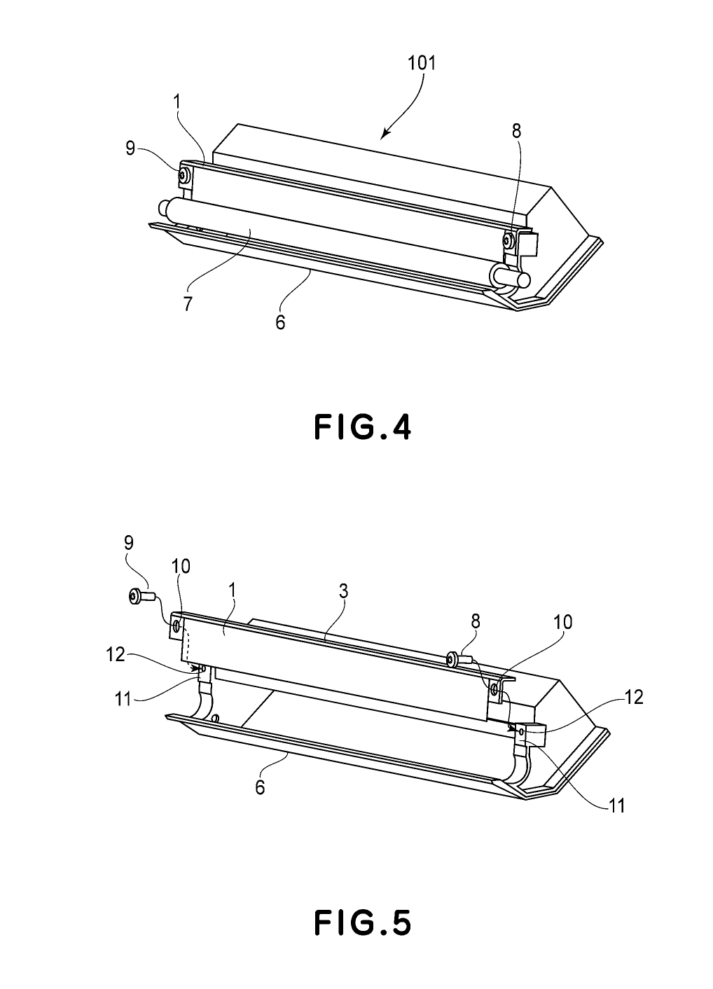

FIG. 4 is a schematic drawing of the development cartridge 101 in this embodiment.

The development cartridge 101 is made up of a developer container 6 which is a part of the frame of the development cartridge 101, a development roller 7, a development blade 1, etc.

One of the characteristic features of the development cartridge 101 in this embodiment is that the development blade 1 is fixed to the developer container 6 with the use of a right-handed screw 8 and a left-handed screw 9. In the following portion of the description of this embodiment, the left- and right-handed screws 8 and 9 may sometimes be referred to simply as screws 8 and 9, respectively.

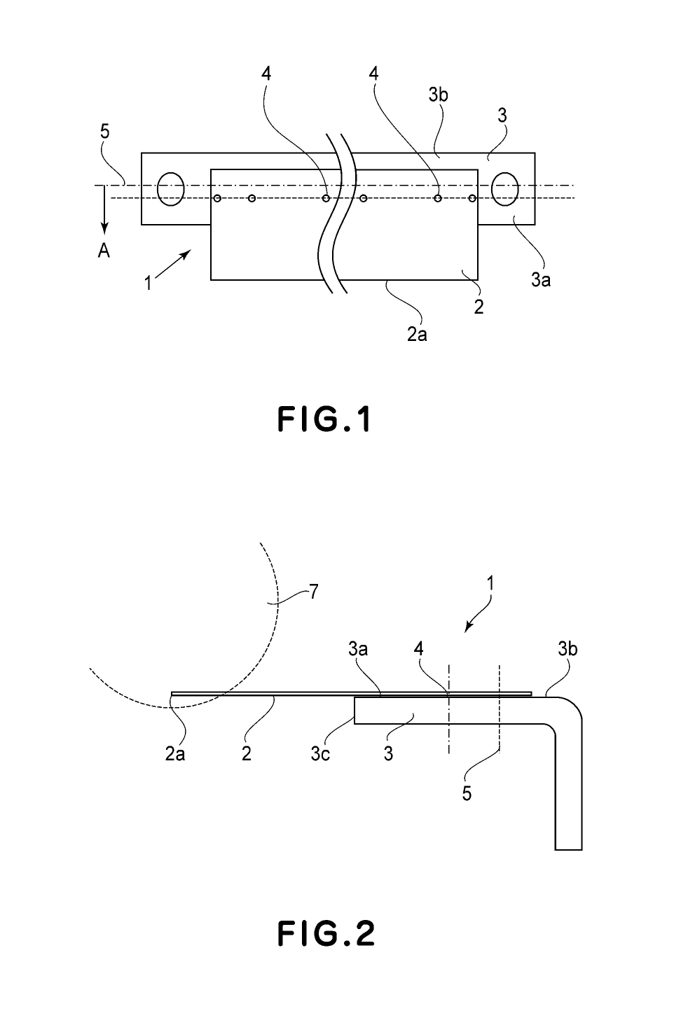

FIGS. 1 and 2 are schematic drawings of the development blade 1 in this embodiment. FIG. 1 shows the front surface side of the development blade 1, and FIG. 2 is a schematic cross-sectional view of the development blade 1.

The development blade 1 is made up of a thin plate 2 (as actual blade) which is roughly 100 μm in thickness, and a base plate 3, which is roughly 1-2 mm in thickness. The base plate 3 is formed by bending a long and narrow rectangular metallic plate in such a manner that the metallic plate becomes L-shaped in cross-section. The thin plate 2 and base plate 3 are welded to each other by a YAG laser, at points 4 of fixation. The thin plate 2 is the actual blade which regulates the amount by which developer is borne by the peripheral surface of the development roller 7. The base plate 3 plays the role of a supporting member which supports the thin plate 2.

One of the characteristic features of this embodiment is the points 4 of fixation of the thin plate, by which the thin plate 2 is fixed to the base plate 3. The points 4 of the base plate 3, to which the points 4 of the thin plate 2 are fixed is in an area 3a of the base plate 3, which is on the functional edge side (where thin plate 2 makes contact with development roller 7 (side indicated by arrow mark A in FIG. 1). The thin plate 2 is welded to the base plate 3 at multiple points. In other words, the thin plate 2 is fixed to the area 3a of the base plate 3. In this embodiment, the material for the thin plate 2 is stainless steel (SUS). However, this embodiment is not intended to limit the present invention in terms of the material for the thin plate 2. For example, the material may be one of the other metallic substances than stainless steel, or resinous substance such as rubber. Also in this embodiment, the method used to fix the thin plate 2 to the base plate 3 is YAG laser welding. However, one of the other fixing methods than YAG welding may be used. Further, in this embodiment, the base plate 3 was bent in such a shape that its cross-section is roughly L-shaped. However, this embodiment is not intended to limit the present invention in terms of cross-section of the base plate. That is, the base plate 3 may be different in shape in terms of cross-section. For example, it may be flat.

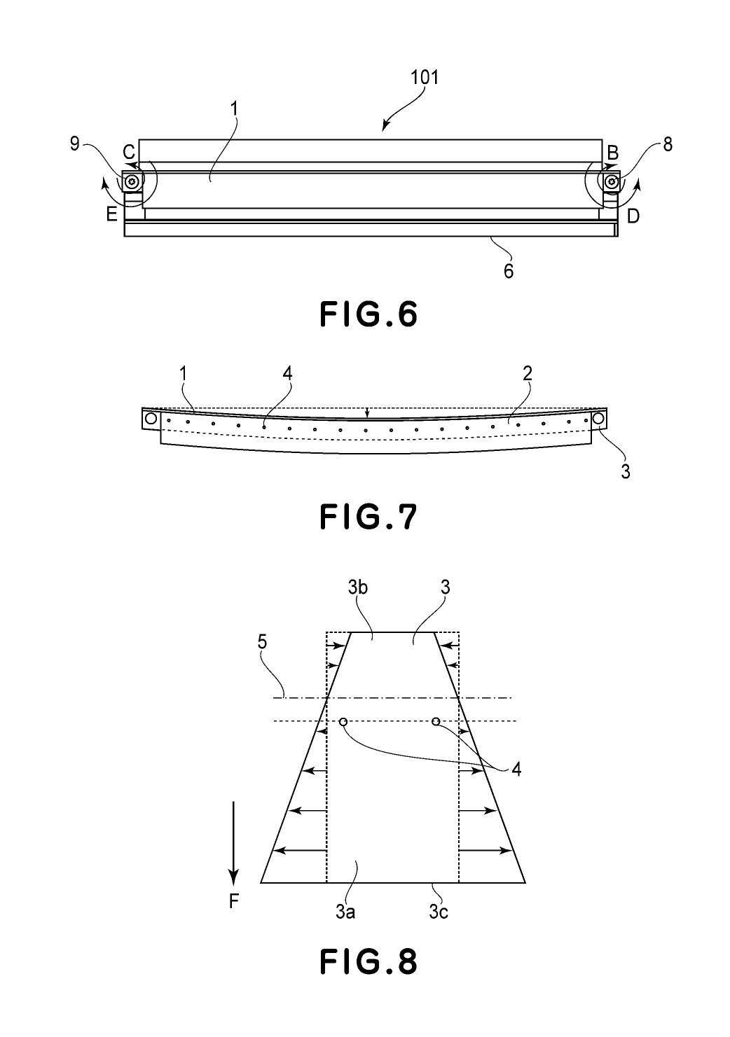

FIGS. 5 and 6 are drawings for describing how the development blade 1 is attached to the developer container 6. The development blade 1 is attached to the developer container 6 by its base plate 3. More specifically, the base plate 3 of the development blade 1 is attached to the blade attachment seat 11, which is the portion of the development container 6, to which the development blade 1 is to be attached, and which functions as the blade supporting portion of the development container 6. More specifically, screws are put through the base plate 3, and are torqued into the blade attachment seat 11.

Referring to FIG. 6, as the development cartridge 101 is seen from the side from which the screws are tightened (downstream side in terms of direction in which screws are driven into base plate 3), with the thin plate 2 being kept on the bottom side of the base plate 3, the development container 6 is provided two blade attachment seats 11, which are on the left and right end portions of the development container 6, one for one, into which left and right screws 9 and 8 are driven, respectively. The state in which the thin plate 2 is kept on the bottom side of the base plate 3 means that the edge 2a side of the thin plate 2, that is, the portion of the thin plate 2 (which contacts development roller 7, with presence of developer between itself and development roller 7), which is closer to the development roller 7 than the opposite edge of the thin plate from the edge 2a, is on the bottom side of the base plate 3.

The screws are put through the blade attachment holes 10 of the base plate 3, put through the holes 12 with which the blade attachment seats 11 of the developer container 6, one for one, and then, are rotated to be tightened. As the screws are tightened, the base plate 3 becomes tightly sandwiched between the head portion of each screw and the corresponding blade attachment seat 11 of the developer container 6. Thus, the development blade 1 is fixed to the developer container 6. As the screws 8 and 9 are turned (torqued), they become tightened while torquing the blade attachment seats 11 in the directions B and C, respectively, in which they are turned. Therefore, the development blade 1 is attached to the developer container 6 while each blade attachment seat 11 is elastically deformed in the direction in which the corresponding screw is turned. That is, the development blade 1 is fixed to the developer container 6, with the blade attachment seats 11 remaining elastically deformed.

As the torque applied to the screws 8 and 9 to tighten the screws 8 and 9 is removed after the completion of tightening of the screws 8 and 9, the blade attachment seats 11 tend to restore their original shape due to their resiliency (elasticity). This resiliency of the blade attachment seats 11 generates torques in the directions D and E, which are opposite from the direction B and C, respectively, and apply to the base plate 3. Thus, the development blade 1 is deformed.

It is preferred that the right and left screws 8 and 9 are tapping screws, which are such screws that create their own threads in the screw holes 12 of the blade attachment seats 11 as they are driven in the screw holes 12, because the amount of torque which a tapping screw applies to the blade attachment seat 11 is significantly greater than that which an ordinary screw applies to the seat 11, and therefore, can deform the seat 11 by a greater amount than an ordinary screw, as it is driven (torqued).

In a case where the screw holes of the blade attachment seats 11 are threaded, the amount of torque necessary to turn the screws 8 and 9 is smaller than in a case where the holes are not threaded. However, as long as the screws 8 and 9 are kept pressed against the developer container 6 while they are driven to be tightened, the fiction between the threads of the screws 8 and 9 and the threads of the screw holes of the seats 11 remain large enough to apply a large amount of torque to the seats 11.

FIG. 7 is a drawing for showing the state of the deformation which occurred as the development blade 1 was attached to the developer container 6. For convenience's sake from the standpoint of making it easier to describe the deformation, the development blade 1 in FIG. 7 is exaggerated in the amount of deformation. FIG. 8 is a disproportionally enlarged schematic drawing of the development blade 1, for showing the state of deformation of the base plate 3 of the development blade 1, as seen from the same direction as FIG. 7. The development roller 7 is in the direction indicated by an arrow mark F.

In the case of the development cartridge 101 in this embodiment, which is structured as described above, as the development blade 1 is attached to the developer container 6, the development blade 1 is deformed because of the described contrivance. Consequently, the development blade 1 is deformed as shown in FIG. 7. As the development blade 1 is deformed, its base plate 3 is deformed as follows. That is, referring to FIG. 8, the base plate 3 is deformed in such a manner that the area 3a which is on the development roller side of the neutral plane 5 (thin plate (actual blade) side) is stretched (deformed so that area 3a is subjected to tensional stress). In comparison, the area 3b which is on the opposite side of the neutral plane 5 from the development roller 7 is compressed (deformed so that area 3b is subjected to compressional stress). That is, the base plate 3 of the development blade 1 is fixed to the developer container 6 in the state shown in FIGS. 7 and 8. The neutral plane 5 is the border between the area 3a which is stretched, and the area 3b which is compressed.

As described above, in this embodiment, the screw holes 12 of the base plate 3, into which the right and left screws 8 and 9 are driven to fix the thin plate 2 to the base plate 3 are in the area 3a of the base plate 3, which are subjected to tensional stress as the base plate 2 is deformed. Therefore, as the development blade 1 is fixed to the developer container 6, the area 3a of the base plate 3 is stretched, and therefore, the thin plate 2 is subjected to tensional force in the lengthwise direction of the thin plate 2 (direction parallel to rotational axis of development roller 7). That is, after the fixation of the development blade 1 to the developer container, the portions 4 of the thin plate 2, by which the thin plate 2 is attached to the base plate 3 remains tensioned in the lengthwise direction of the thin plate 2, causing thereby the edge 2a of the thin plate 2 to be tensioned in its lengthwise direction. Further, the portions 4 are not in the areas 3b which are subjected to the compressional stress. Therefore, the portions 4 are not subjected to the compressional stress, and therefore, the thin plate 2 is not subjected to compressional force.

As described above, the base plate 3 of the development blade 1 is deformed by the resiliency of the elastically deformed blade attachment seats 11. Consequently, the thin plate 2 of the development blade 1 is tensioned in its lengthwise direction.

Because the development blade 1 and developer container 6 are structured as described above, not only is it possible to prevent the edge portion 2a of the thin plate 2 of the development blade 1, but also, the portions 4, from being deformed in the pattern of waves by compressional pressure. Therefore, the edge portion 2a of the thin plate 2 remains in contact with the peripheral surface of the development roller 7 in such a manner that the state of contact between the edge portion 2a and the peripheral surface of the development roller 7 is uniform in terms of the lengthwise direction of the thin plate 2 (development roller 7). Further, after the attachment of the development blade 1 to the developer container 6, the portions 4 and the edge 2a of the thin plate 2 of the development blade 1 remain tensioned in the lengthwise direction of the development blade 1. Therefore, even if they are subjected to compressional force after the attachment of the development blade 1 to the developer container 6, the compressional force is canceled by the tensional force, as long as the compressional force is not excessive. Therefore, even if the base plate 3 of the development blade 1 is deformed by the mechanical and/or thermal stress to which the base plate 3 is subjected while the image forming apparatus is in use, it is unlikely that the edge 2a of the thin plate 2 becomes wavy.

It should be noted here that if the tensional force to which the portions 4 are subjected becomes excessive, it is possible that separation or the like will occur at the portions 4. Therefore, it is preferred that the portions 4 are in the portion of the area 3a of the base plate 3, which is closer to the neutral plane 5 than the edge 3c, that is, development roller side edge, of the base plate 3. Because the development blade 1 and developer container 6 in this embodiment are structured as described above, the developing device in this embodiment remains stable in terms of image quality.

As described above, according to the present invention, in order to make the thin plate 2 of the development blade 1 remain tensioned in its lengthwise direction, the base plate 3 of the development blade 1 is fixed to the developer container 6 in such a manner that the area 3a of the base plate 3 of the development blade 1 is elastically stretched, and the area 3b of the base plate 3 of the development blade 1 is compressed. Further, the points of attachment of the thin plate 2 to the base plate 3 are in the area 3a of the base plate 3, which remains elastically stretched. Therefore, it is ensured that the development blade (edge 2a of thin plate of development blade 1) does not become wavy.

In this embodiment, the development blade 1 is fixed to the developer container 6, by its base plate 3, while the blade attachment seats 11 of the developer container 6 remains elastically deformed. That is, the development blade 1 and developer container 6 are structured so that the base plate 3 of the development blade 1 is elastically deformed by the resiliency of the elastically deformed blade attachment seats 11. Further, screws are used to fix the development blade 1 in order to deform the blade attachment seats 11 of the developer container 6 by the utilization of the friction which occurs between the screws and the wall of the screw hole as the screws are driven (torqued). That is, the base plate 3 of the development blade 1 is elastically deformed by the simple structural contrivance. However, this embodiment is not intended to limit the presence invention in scope. That is, the present invention is applicable to any development cartridge as long as it is structured so that the base plate of its development blade is fixed to its developer container so that it remains elastically deformed as described above.

Further, the developing device in this embodiment is in the form of a development cartridge 101, which is removably installable by a user in the main assembly of an image forming apparatus. However, the present invention is also applicable to an image forming apparatus structured so that its developing device remains fixed to the main assembly of the image forming apparatus, that is, a user does not remove the developing device from the main assembly.

Further, the present invention is also applicable to an image forming apparatus structured so that its developing device and photosensitive drum (15) are integrated in the form of a cartridge to enable the developing device and photosensitive drum (15) to be removably mountable together in the main assembly of the image forming apparatus. That is, the present invention is also applicable to an image forming apparatus structured so that its development cartridge (101) includes the photosensitive drum. Incidentally, a development cartridge (101) having a photosensitive drum (15) is equivalent to a process cartridge.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 092766/2013 filed Apr. 25, 2013, which is hereby incorporated by reference.

1. A developing device for an image forming apparatus, comprising:
a developing roller for carrying a developer;
a developing blade including a blade member for regulating a developer amount carried on a surface of the developing roller and a supporting member for supporting said blade member; and
a frame supporting said supporting member:
wherein said supporting member is fixed to said frame in a state that a first region thereof adjacent said blade member tends to expand and a second region thereof remote from said blade member tends to contract, such that a stretching force is applied to said blade member in a rotation axial direction of said developing roller, and said blade member is fixed to said supporting member in the first region.

2. A device according to claim 1, wherein said supporting member is fixed to said frame in a state that a supporting member fixing portion of said frame for fixing said supporting member is elastically deformed, and a restoring force of said supporting member fixing portion deforms said supporting member to apply a stretching force to said blade member.

3. A device according to claim 2, wherein the fixing of said supporting member to said frame is effected by threading a screw into said supporting member fixing portion through said supporting member, and said supporting member fixing portion elastically deforms by tightening the screw.

4. A device according to claim 3, wherein as seen in a direction in which the screw advances in threading in a state that said blade member takes a lower position relative to said supporting member, said supporting member fixing portion is provided at each of right and left portions of said frame, and a right-hand screw is threaded into a right side supporting member fixing portion, and a left-hand screw is threaded into a left side supporting member fixing portion.

5. A device according to claim 3, wherein during threading the screw into said frame, the screw is pressed against said supporting member fixing portion.

6. An apparatus according to claim 3, wherein the screw is a tapping screw.

7. A device according to claim 1, wherein said blade member is fixed at a position closer to a boundary between the first region and the second region than to an end portion of the first region.

8. A device according to claim 1, wherein said developing device is a cartridge detachably mountable to an apparatus main assembly of the image forming apparatus.

9. A process cartridge detachably mountable to a main assembly of a image forming apparatus, said process cartridge comprising:
an image bearing member for bearing an electrostatic latent image;
a developing roller;
a developing blade including a blade member for regulating a developer amount carried on a surface of the developing roller and a supporting member for supporting said blade member; and
a frame to which said supporting member is fixed,
wherein said supporting member is fixed to said frame in a state that a first region thereof adjacent said blade member tends to expand and a second region thereof remote from said blade member tends to contract, such that a stretching force is applied to said blade member in a rotation axial direction of said developing roller, and said blade member is fixed to said supporting member in the first region.

10. A process cartridge according to claim 9, wherein said supporting member is fixed to said frame in a state that a supporting member fixing portion of said frame for fixing said supporting member is elastically deformed, and a restoring force of said supporting member fixing portion deforms said supporting member to apply a stretching force to said blade member.

11. A process cartridge according to claim 10, wherein the fixing of said supporting member to said frame is effected by threading a screw into said supporting member fixing portion through said supporting member, and said supporting member fixing portion elastically deforms by tightening the screw.

12. A process cartridge according to claim 11, wherein as seen in a direction in which the screw advances in threading in a state that said blade member takes a lower position relative to said supporting member, said supporting member fixing portion is provided at each of right and left portions of said frame,
a right-hand screw is threaded into a right side supporting member fixing portion, and a left-hand screw is threaded into a left side supporting member fixing portion.

13. A process cartridge according to claim 11, wherein during threading the screw into said frame, the screw is pressed against said supporting member fixing portion.

14. A process cartridge according to claim 11, wherein the screw is a tapping screw.

15. A process cartridge according to claim 9, wherein said blade member is fixed at a position closer to a boundary between the first region and the second region than to an end portion of the first region.

16. An image forming apparatus for forming an image on a recording material, said image forming apparatus comprising:
a developing roller;
a developing blade including a blade member for regulating a developer amount carried on a surface of the developing roller and a supporting member for supporting said blade member;
a frame to which said supporting member is fixed,
a feeding member for feeding the recording material; and
a fixing device for fixing a developer image on the recording material;
wherein said supporting member is fixed to said frame in a state that a first region thereof adjacent said blade member tends to expand and a second region thereof remote from said blade member tends to contract, such that a stretching force is applied to said blade member in a rotation axial direction of said developing roller, and
said blade member is fixed to said supporting member in the first region.

17. An apparatus according to claim 16, wherein said supporting member is fixed to said frame in a state that a supporting member fixing portion of said frame for fixing said supporting member is elastically deformed, and a restoring force of said supporting member fixing portion deforms said supporting member to apply a stretching force to said blade member.

18. An apparatus according to claim 17, wherein the fixing of said supporting member to said frame is effected by threading a screw into said supporting member fixing portion through said supporting member, and said supporting member fixing portion elastically deforms by tightening the screw.

19. An apparatus according to claim 18, wherein as seen in a direction in which the screw advances in threading in a state that said blade member takes a lower position relative to said supporting member, said supporting member fixing portion is provided at each of right and left portions of said frame, a right-hand screw is threaded into a right side supporting member fixing portion, and a left-hand screw is threaded into a left side supporting member fixing portion.

20. An apparatus according to claim 18, wherein during threading the screw into said frame, the screw is pressed against said supporting member fixing portion.
